(19) United States
(12) Patent Application Publication
(10) Pub. No.: US 2006/0155701 A1
(43) Pub. Date: Jul. 13, 2006

(54) Fast implementation of recursive diamond search

(75) Inventors: Xiaojie Huang, Xuchang (CN); Xingguo Wang, Santa Clara, CA (US)

Correspondence Address: PATENT LAW GROUP LLP, 2635 NORTH FIRST STREET, SUITE 223, SAN JOSE, CA, 95134, US

(73) Assignee: ArcSoft, Inc.

(21) Appl. No.: 11/035,661

(22) Filed: Jan. 13, 2005

(51) Int. Cl. G06F 17/30; G06F 7/00

(52) U.S. Cl. 707/6

(57) ABSTRACT

A method for block matching includes performing a first search for a matching block in a frame using a search pattern centered at a first center point and determining a best point that produces a close match. If the best point does not produce a match satisfying a criterion, the method further includes storing the first center point in an array, setting the best point as a second center point, and performing a second search using the search pattern centered at the second center point. Performing the second search includes (1) at least approximating distances between (a) points in the search pattern centered at the second center point and (b) center points stored in the array; (2) excluding any point that has at least one distance less than a threshold; and (3) performing the second search for remaining points in the search pattern centered at the second center point.

### FIELD OF INVENTION

This invention relates to motion estimation and more specifically to a method for searching corresponding blocks between two frames.

### DESCRIPTION OF RELATED ART

One important aspect of a video encoder is the removal of temporal redundancy by estimating the motion between a current frame and a reference frame. A wide variety of motion estimations exists. Typically, a current frame and a reference frame are broken into blocks (e.g., macro-blocks of 16 by 16 pixels) and a search is performed to locate the block in the reference frame that satisfies some minimum error criteria from the current frame. A popular error criteria used in motion estimation is the sum of absolute difference (SAD). Once the best matching block is located, a motion vector field is encoded per block corresponding to the absolute displacement from the current frame block. The efficient search for the block corresponding to the minimum SAD is the subject of on-going research.

In the Diamond Search algorithm, a diamond pattern is used in the search process. The algorithm starts in the co-located block in the reference frame and performs eight SAD's around the diamond center. Once the minimum SAD location is found, the diamond center is displaced to the optimum location and a new diamond search is executed. However, the same SAD locations can be repeated between diamond centers, thereby making the process inefficient.

Thus, what is needed is a method that addresses the disadvantages of the Diamond Search algorithm.

### BRIEF DESCRIPTION OF THE DRAWINGS

FIG. 1 is a flowchart of a method for block matching between frames in motion estimation for one embodiment of the invention.

FIGS. 2 to 5 illustrate an exemplary search using the method of FIG. 1 in one embodiment of the invention.

Use of the same reference numbers in different figures indicates similar or identical elements.

### SUMMARY

In one embodiment of the invention, a method for block matching includes performing a first search for a matching block in a frame using a search pattern centered at a first center point and determining a best point that produces a close match. If the best point does not produce a match satisfying a criterion, the method further includes storing the first center point in an array, setting the best point as a second center point, and performing a second search using the search pattern centered at the second center point. Performing the second search includes (1) at least approximating distances between (a) points in the search pattern centered at the second center point and (b) center points stored in the array; (2) excluding any point that has at least one distance less than a threshold; and (3) performing the second search for remaining points in the search pattern centered at the second center point.

### DETAILED DESCRIPTION

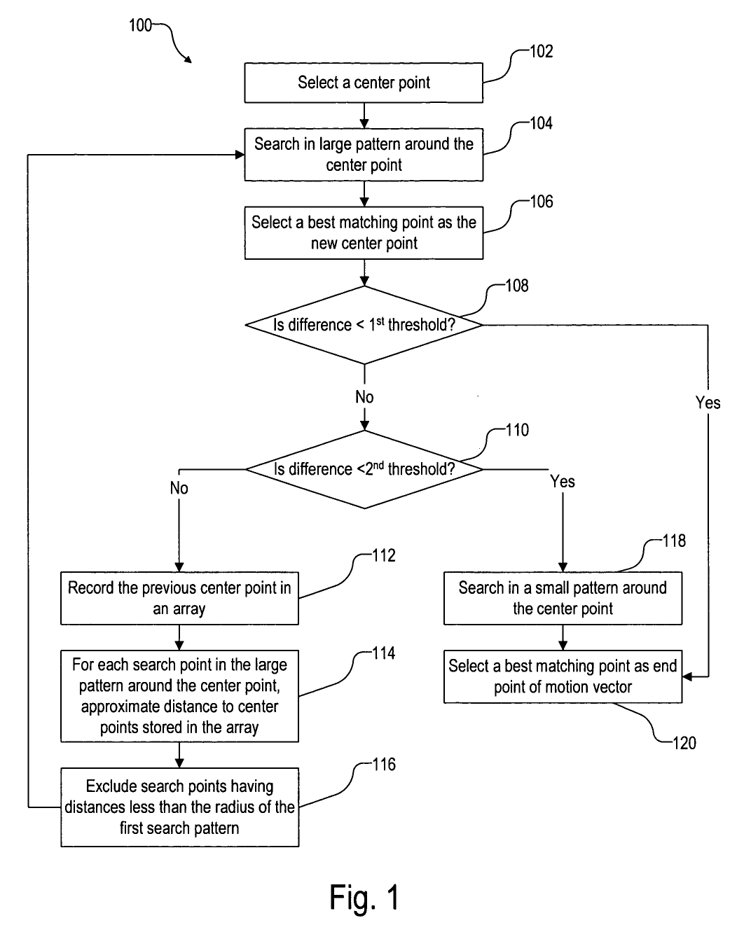

FIG. 1 is a flowchart of a method 100 to match a selected block in a current frame with a block in a reference frame for motion estimation in one embodiment of the invention. Method 100 may be implemented in software, hardware, or a combination thereof. For example, method 100 may be implemented in a MPEG software or hardware codec.

In step 102, an initial center point on a reference frame is selected for the current iteration. The initial center point in located at the same position in the reference frame as the center of the selected block in the current frame (i.e., they are co-located).

In step 104, a search is performed to match blocks located at and around the center point to the selected block in the current frame. In one embodiment, a diamond search pattern including nine search points (including the center point) is used. The blocks at the nine search points are compared with the selected block in the current frame. In one embodiment, the sum of absolute difference (SAD) is used to compare the blocks.

In step 106, the search point that has the block with the smallest difference is selected (hereafter referred to as the “best search point”) as the new center point.

In step 108, it is determined if the smallest difference is less than a first threshold. If the smallest difference is less than the first threshold, then it is assumed that the block at the new center point matches the selected block in the current frame. If the smallest difference is less than the first threshold, then step 108 is followed by step 120. Otherwise step 108 is followed by step 110.

In step 110, it is determined if the smallest difference is less than a second threshold. If the smallest difference is less than the second threshold, then it is assumed that the block in the reference frame that matches the selected block in the current frame is nearby and a smaller search pattern will be used to accelerate the search. If the smallest difference is less than a second threshold, then step 110 is followed by step 118. Otherwise step 110 is followed by step 112.

In step 112, the previous center point is recorded in an array. The array stores all the previous center points in past iterations. Step 112 is followed by step 114.

In step 114, the search points for the search pattern at the new center point are determined. Note that these search points may include previous search points that have already been compared with the selected block in the current frame.

Next, the distances between the search points and previous center points stored in the array are approximated or exactly determined. In one embodiment, the distances is approximated as follows:
D≅|x−Xᵢ+|y−Y|,
where D is the distance, x and y are coordinates of a search point, and Xᵢ and Yᵢ are coordinates of the ith center pointer in the array. Step 114 is followed by step 116.

In step 116, any current search point that has one distance from previous center points less than the radius of the search pattern used in step 104 is excluded from further processing. This is because such a search point would have already been compared as it falls within a circle centered at a previous center point. Step 116 is followed by step 104 and method 100 repeats as described above.

In step 118, a smaller search is performed to match blocks located at and around the new center point to the selected block in the current frame. In one embodiment, a smaller diamond search pattern (e.g., pattern 504 in FIG. 5) includes five search points. Step 118 is followed by step 120.

In step 120, the search point that has the block producing the smallest difference is selected as one of the end points of a motion vector between matching blocks in current frame and the reference frame.

Of course, method 100 can be repeated for additional blocks in the current frame and the resulting motion vectors can be processed to approximate the true motion vector between the current frame and the reference frame.

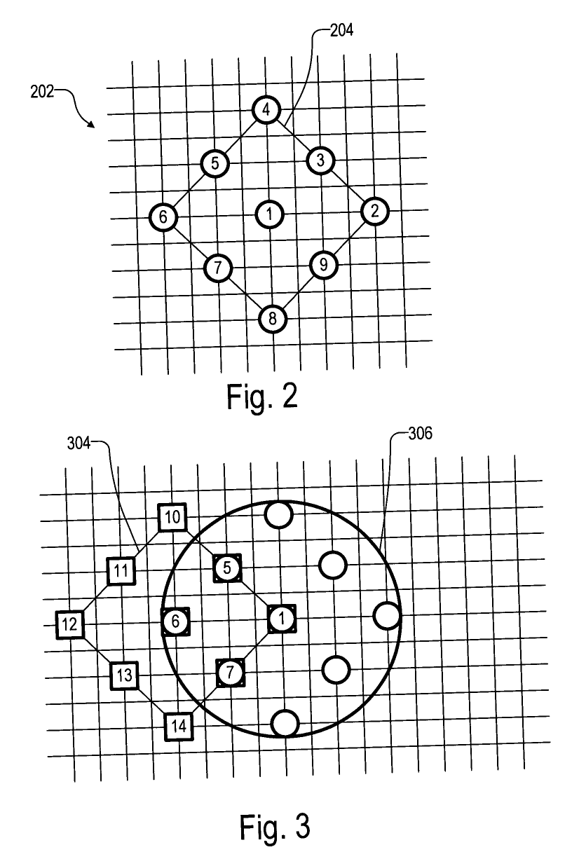

FIGS. 2 to 5 are now explained to demonstrate method 100 in one embodiment of the invention. Referring to both FIGS. 1 and 2, in step 102, a center point 1 in reference frame 202 is selected. Center point 1 is located in a reference frame 202 at a location corresponding to the center point of a selected block in the current frame. Note that the grid on reference frame 202 are arbitrary units provided to show the spacing between search points.

In step 104, a large diamond pattern 204 at center point 1 is searched for a match for the selected block in the current frame. Specifically, diamond pattern 204 includes center point 1 and search points 2 to 9. In this example, assume search point 6 provides a close match.

In step 106, search point 6 is set as the new center point. In step 108, the difference between the block at center point 6 and the selected block in the current frame is compared with the first threshold. In this example, assume the difference is not less than the first threshold because the block at center point 6 in reference frame 202 is not the best match for the selected block in the current frame. Thus step 106 is followed by step 110.

In step 110, the difference between the block at center point 6 in reference frame 202 and the selected block in the current frame is compared with the second threshold. In this example, assume the difference is not less than the second threshold because the block in reference frame 202 that best matches the selected block in the current frame is not located close to center point 6. Thus step 110 is followed by step 112.

In step 112, previous center point 1 is stored in an array.

Referring to both FIGS. 1 and 3, in step 114, the search points for a large diamond pattern 304 at center point 6 are determined. Specifically, diamond pattern 304 includes search points 1, 5, 6, 7, 10, 11, 12, 13, and 14. Next, the distances between the search points and the previous center points stored in the array are approximated. Specifically, the distances between (1) search points 1, 5, 6, 7, 10, 11, 12, 13, and 14 and (2) center point 1 are approximated.

In step 116, those search points having distances less than the radius of the large diamond pattern (i.e., those search points falling within circle 306) are excluded from further processing. Specifically, search points 1, 5, 6, and 7 are excluded from further processing. Step 116 is followed by step 104.

In step 104, diamond pattern 304 at center point 6 is searched for a match for the selected block in the current frame. In this example, assume search point 10 provides a close match.

In step 106, search point 10 is set as the new center point.

In step 108, the difference between the block at center point 10 and the selected block in the current frame is compared with the first threshold. In this example, assume the difference is not less than the first threshold. Thus step 106 is followed by step 110.

In step 110, the difference between the block at center point 10 and the selected block in the current frame is compared with the second threshold. In this example, assume the difference is not less than the second threshold. Thus step 110 is followed by step 112.

In step 112, previous center point 6 is stored in the array.

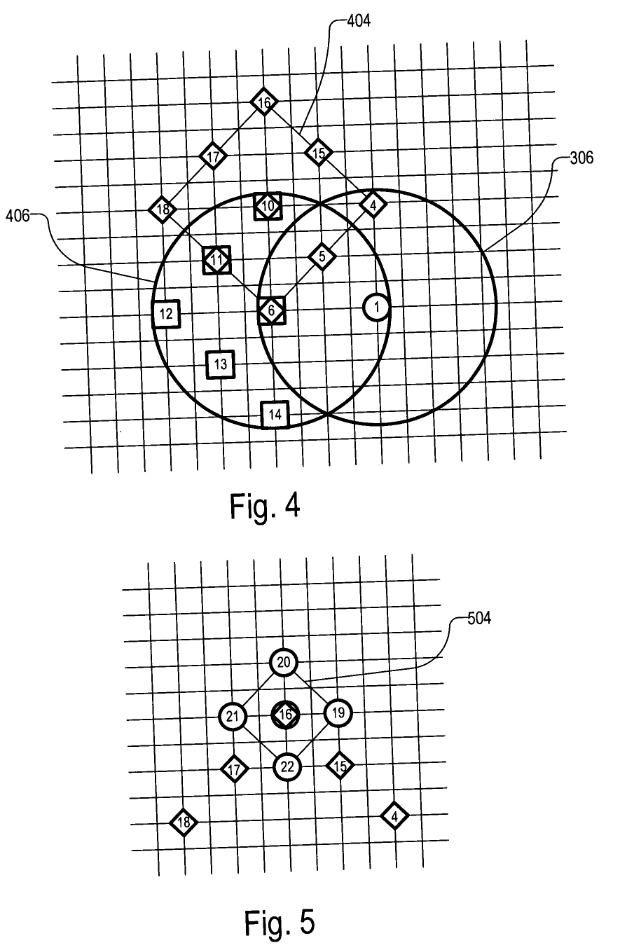

Referring to both FIGS. 1 and 4, in step 114, the search points for a large diamond pattern 404 at center point 10 are determined. Specifically, diamond pattern 404 includes search points 4, 5, 6, 10, 11, 15, 16, 17, and 18. Next, the distances between the search points and the previous center points stored in the array are approximated. Specifically, the distances between (1) search points 4, 5, 6, 10, 11, 15, 16, 17, and 18 and (2) center points 1 and 6 are approximated.

In step 116, those search points having distances less than the radius of the large diamond pattern (i.e., those search points falling within circles 306 and 406) are excluded from further processing. Specifically, search points 4, 5, 6, 10, and 11 are excluded from further processing. Step 116 is followed by step 104.

In step 104, diamond pattern 404 at center point 10 is searched for a match for the selected block in the current frame. In this example, assume search point 16 provides a close match.

In step 106, search point 16 is set as the new center point. In step 108, the difference between the block at center point 16 and the selected block in the current frame is compared with the first threshold. In this example, assume the difference is not less than the first threshold. Thus step 106 is followed by step 110.

In step 110, the difference between the block at center point 16 and the selected block in the current frame is compared with the second threshold. In this example, assume the difference is less than the second threshold. Thus step 110 is followed by step 118.

Referring to both FIGS. 1 and 5, in step 118, a small diamond pattern 504 around center point 16 is searched for a best match for the selected block in the current frame. In this example, assume search point 21 provides the best match.

In step 120, search point 21 is set as one of the end points of the motion vector between the current frame and reference frame 202.

Various other adaptations and combinations of features of the embodiments disclosed are within the scope of the invention. Numerous embodiments are encompassed by the following claims.

What is claimed is:

1. A method for block matching between a first frame and a second frame, comprising:
performing a first search for a matching block in the first frame using a search pattern centered at a first center point;
from points in the search pattern centered at the first center point, determining a best point that produces a close match in the first search;
if the best point does not produce a match satisfying a criterion:
storing the first center point in an array;
setting the best point as a second center point;
performing a second search for the matching block in the first frame using the search pattern centered at the second center point, wherein said performing the second search comprises:
for each point in the search pattern centered at the second center point, at least approximating distances to center points stored in the array;
excluding any point in the search pattern centered at the second center point that has at least one distance less than a threshold;
performing the second search for remaining points in the search pattern centered at the second center point.

2. The method of claim 1, wherein the search pattern comprises a diamond search pattern.

3. The method of claim 1, wherein said determining a best point that produces a close match in the first search comprises:
determining differences between (1) blocks centered at the points in the search pattern in the first frame and (2) a block in the second frame, the close match being a point that produces a smallest difference.

4. The method of claim 3, wherein the best point does not produce a match satisfying a criterion when the smallest difference is greater than a threshold.

5. The method of claim 1, wherein said approximating distances to center points stored in the array comprises approximating actual distances as follows:
D≅|x−Xᵢ|+y−Yᵢ|,
where D is the distance, x and y are coordinates of the second center point, and Xi and Yi are coordinates of the ith center pointer in the array.

6. The method of claim 1, further comprising:
if the best point produces a match satisfying the criterion:
setting the best point as the second center point;
performing a third search for the matching block in the first frame using a another search pattern centered at the second center point;
from points in said another search pattern centered at the second center point, determining another best point that produces a close match in the second search;
storing said another best point for motion estimation.

7. The method of claim 6, wherein said another search pattern comprises a smaller search pattern than the search pattern.

8. The method of claim 6, further comprising:
if the best point produces a match satisfying another criterion, storing the best point for motion estimation.

9. A method for block matching in motion estimation, comprising:
performing a first search for a matching block in a frame using a first search pattern centered at a first center point;
from points in the first search pattern centered at the first center point, determining a first best point that produces a close match in the first search;
if the first best point does not produce a match satisfying a first criterion:
storing the first center point in an array;
setting the first best point as a second center point;
performing a second search for the matching block in the frame using the first search pattern centered at the second center point, wherein said performing the second search comprises:
for each point in the first search pattern centered at the second center point, at least approximating distances to center points stored in the array;
excluding any point in the first search pattern centered at the second center point that has at least one distance less than a threshold;
performing the second search for remaining points in the first search pattern centered at the second center point;
if the first best point produces a match satisfying the first criterion:
setting the first best point as the second center point;
performing a third search for the matching block in the frame using a second search pattern centered at the second center point;
from points in the second search pattern centered at the second center point, determining a second best point that produces a close match in the third search;
storing the second best point for motion estimation;
if the first best point produces a match satisfying a second criterion, storing the first best point for motion estimation.
